(19) United States
(12) Patent Application Publication
(10) Pub. No.: US 2008/0031366 A1
(43) Pub. Date: Feb. 7, 2008

(54) Network control apparatus and method for enabling network chip

(75) Inventors: Cyuan-Tai Lin, Taipei (TW); Ching-Wen Chu, Taipei (TW); Yi-Hsin Hsiao, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 11/822,479

(22) Filed: Jul. 6, 2007

(30) Foreign Application Priority Data
Jul. 7, 2006 (TW) 95124917

(51) Int. Cl. H04L 25/00

(52) U.S. Cl. 375/257

(57) ABSTRACT

A network control apparatus includes a connector, a controller and a power switch. When a network cable is connected to the connector, the connector outputs a detecting signal to the controller, and the controller outputs a power control signal to the power switch. After the power switch receives the power control signal, a power voltage is transmitted to a network chip to make the network chip work properly.

This application claims the benefit of Taiwan application Serial No. 95124917, filed Jul. 7, 2006, the subject matter of which is incorporated herein by reference.

### BACKGROUND OF THE INVENTION

1. Field of the Invention

The invention relates in general to a network control apparatus, and more particularly to a network control apparatus with a power-saving effect.

2. Description of the Related Art

FIG. 1 (Prior Art) is a block diagram showing a conventional network system. As shown in FIG. 1, a network cable 101 is connected to an RJ45 connector 102. A data bus 103 is disposed between the RJ45 connector 102 and a network chip 104. Network data is transmitted from the network chip 104 to the connector 102 through the data bus 103, and then transmitted to the outside through the network cable 101. Alternatively, the network data is transmitted from the outside to the connector 102 through the network cable 101, and then transmitted to the network chip 104 through the data bus 103. The network chip 104 always receives a power voltage Vp no matter whether the network cable 101 is connected to the RJ45 connector 102 or not. Thus, when the network cable 101 is not connected to the RJ45 connector 102, i.e. when the network is not used, the network chip 104 still continuously consumes the power. When the network system is used in a portable electronic device, such as a notebook computer, the too-large power consumption of the network chip 104 shortens the durability of the battery in the electronic device.

### SUMMARY OF THE INVENTION

The invention is directed to a network control apparatus. A power voltage is transmitted to a network chip to enable the network chip properly when a network cable is connected to the network control apparatus. When the network cable is not connected to the network control apparatus, the power voltage is not transmitted to the network chip. Thus, when the network is not used, the network chip does not consume the voltage so that the power-saving effect is achieved.

According to a first aspect of the present invention, a network control apparatus including a connector, a controller and a power switch is provided. When a network cable is connected to the connector, a detecting signal is outputted. When the controller receives the detecting signal, a network control signal is outputted to the power switch. When the power switch receives the network control signal, the power switch turns on to transmit a power voltage to a network chip to enable the network chip.

According to a second aspect of the present invention, a method for enabling a network chip is provided. The method includes the following steps. First, it is detected whether a network cable is connected to a connector. Next, if the network cable is connected to the connector, a detecting signal is outputted. Then, a controller outputs a network control signal according to the detecting signal. Finally, a power switch transmits a power voltage to the network chip according to the network control signal to enable the network chip.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram showing a conventional network system.

FIG. 2 is a block diagram showing a network control apparatus according to an embodiment of the invention.

FIG. 3 is a block diagram showing a network control apparatus according to a preferred embodiment of the invention.

FIG. 4 is a flow chart showing a method for enabling a network chip in the network control apparatus of FIG. 3.

### DETAILED DESCRIPTION OF THE INVENTION

In the network control apparatus of the invention, when a network cable is connected to the network control apparatus, i.e. when the network control apparatus starts to operate, a power voltage is transmitted to a network chip to make the network chip operate properly. When the network cable is not connected to a connector, i.e. when the network is not used, the power voltage is not transmitted to the network chip. Thus, when the network is not used, the network chip does not consume the electric power so that the power-saving effect can be achieved.

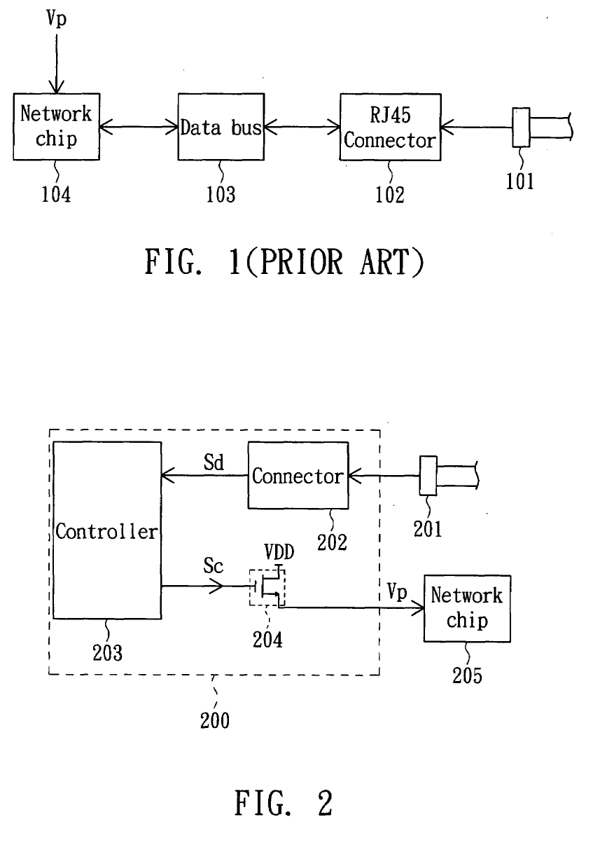

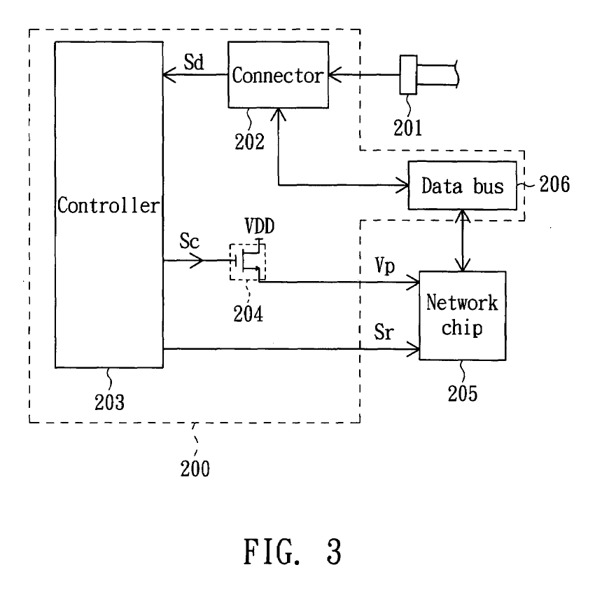

FIG. 2 is a block diagram showing a network control apparatus 200 according to an embodiment of the invention. Referring to FIG. 2, the network control apparatus 200 includes a connector 202, a controller 203 and a power switch 204. The connector 202, for example, an RJ45 connector, is selectively connected to a network cable 201. The controller 203, for example, an embedded controller, receives a detecting signal Sd outputted from the connector 202. The power switch 204 is an N-type metal oxidation semiconductor transistor (NMOS) in this embodiment, or may be, for example, a P-type metal oxidation semiconductor transistor (PMOS). The power switch 204 is controlled by a network control signal Sc outputted from the controller 203. The power switch 204 has a drain coupled to a voltage source VDD and a source coupled to a network chip 205. When the power switch 204 receives the network control signal Sc, the power switch 204 turns on and outputs a power voltage Vp to the network chip 205 from its source.

When the network cable 201 is connected to the network control apparatus 200, the network control apparatus 200 starts to output the power voltage Vp to the network chip 205 to enable the network chip 205. The detailed operation of the network control apparatus 200 will be described in the following. When the network cable 201 is connected to the connector 202, the connector 202 outputs the detecting signal Sd to the controller 203 to notify the controller 203 that the network cable 201 has been connected. The detecting signal Sd may change from a high level to a low level or from the low level to the high level. When the controller 203 receives the detecting signal Sd, the controller 203 outputs the network control signal Sc to the power switch 204. The network control signal Sc is for controlling the power switch 204. When the power switch 204 receives the network control signal Sc, the power switch 204 turns on and transmits the power voltage Vp to the network chip 205. After the network chip 205 receives the power voltage Vp, the network chip 205 starts to work properly.

A detecting pin of the connector 202 in this embodiment is provided to detect whether the network cable 201 has been connected. When the network cable 201 is connected to the connector 202, the network cable 201 touches the detecting pin so that the connector 202 outputs the detecting signal Sd.

When the network cable 201 is not connected to the connector 202, the power switch 204 electrically isolates the power voltage Vp from the network chip 205, and the network chip 205 cannot receive the power voltage Vp. Thus, when the network is not used, the network chip cannot consume the electric power so that the power-saving effect is achieved.

FIG. 3 is a block diagram showing a network control apparatus according to a preferred embodiment of the invention. Referring to FIG. 3, what is different from the above-mentioned embodiment is that the network control apparatus of this embodiment further includes a data bus 206, and the controller outputs a network control signal and further outputs a reset signal Sr for resetting the network chip 205. The operation of the network control apparatus according to the preferred embodiment of the invention will be described in the following. When the network cable 201 is connected to the connector 202, the connector 202 outputs the detecting signal Sd to the controller 203. After the controller 203 receives the detecting signal Sd, the network control signal Sc is outputted to the power switch 204, and then the power switch 204 outputs the power voltage Vp to the network chip 205. After the controller 203 receives the detecting signal Sd, the controller 203 also outputs the reset signal Sr to reset the network chip 205.

In addition, network data may be transmitted from the outside to the network chip 205 through the data bus 206, or transmitted from the network chip 205 to the outside through the data bus 206.

The connector 202 according to the embodiment of the invention is the RJ45 connector having the detecting pin for detecting whether the network cable is connected. In practice, however, any connector capable of detecting whether the network cable is connected can be used without departing from the scope of the invention. In addition, the controller 203 according to the embodiment of the invention may also be another controller, such as a microprocessor or a south bridge chip. The power switch 204 is not limited to the NMOS switch proposed in the embodiment of the invention. Any other switch element, such as a PMOS or a bipolar interface transistor (BJT), may be used alternatively.

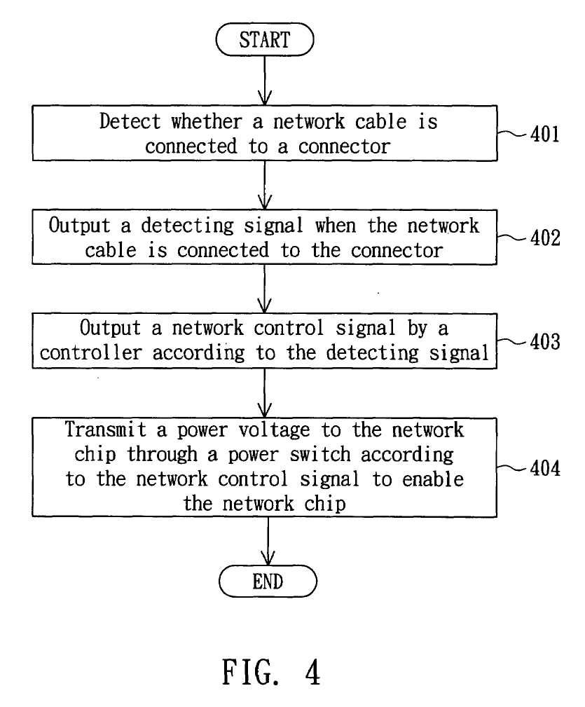

FIG. 4 is a flow chart showing a method for enabling a network chip in the network control apparatus of FIG. 3. In step 401, detect whether the network cable 201 is connected to the connector 202. Next, in step 402, output the detecting signal Sd when the network cable 201 is connected to the connector 202. In step 403, output the network control signal Sc according to the detecting signal Sd by the controller 203 to control the power switch 204. Finally, in step 404, transmit the power voltage Vp to the network chip 205 according to the network control signal Sc through the power switch 204 to enable the network chip 205. In addition, further output the reset signal Sr by the controller 203 to reset the network chip 205.

In the network control apparatus according to the invention, the power voltage is controlled whether to output to the network chip by detecting whether the network cable is connected to the connector. When the network cable is connected to the connector, the network chip starts to receive the power voltage and thus to work properly. When the network cable is not connected to the connector, i.e. the network is not used, the network chip cannot receive the power voltage and cannot consume the electric power. Thus, the network control apparatus of the invention can achieve the power-saving effect.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A network control apparatus, comprising:
a connector for outputting a detecting signal when a network cable is connected to the connector;
a controller for receiving the detecting signal and thus outputting a network control signal;
a power switch, which turns on when receiving the network control signal, and transmits a power voltage to a network chip to enable the network chip.

2. The apparatus according to claim 1, wherein the controller further outputs a reset signal to the network chip, and the controller outputs the reset signal to reset the network chip when the network chip receives the power voltage.

3. The apparatus according to claim 1, further comprising a data bus connected between the connector and the network chip and transmits a network data to the network chip.

4. The apparatus according to claim 1, wherein the connector is an RJ45 connector.

5. The apparatus according to claim 1, wherein the power switch is a P-type metal oxidation semiconductor transistor (PMOS) or an N-type metal oxidation semiconductor transistor (NMOS).

6. The apparatus according to claim 1, wherein the controller is a south bridge chip.

7. The apparatus according to claim 1, wherein the controller is an embedded controller.

8. The apparatus according to claim 1, wherein the connector further comprises at least one detecting pin, and when the network cable is connected to the connector, the network cable contacts the detecting pin to enable the connector to output the detecting signal.

9. A method for enabling a network chip, the method comprising the steps of:
detecting whether a network cable is connected to a connector;
outputting a detecting signal when the network cable is connected to the connector;
outputting a network control signal by a controller according to the detecting signal; and
transmitting a power voltage to the network chip through a power switch according to the network control signal to enable the network chip.

10. The method according to claim 9, wherein the detecting signal changes from a high level to a low level.

11. The method according to claim 9, wherein the detecting signal changes from a low level to a high level.

12. The method according to claim 9, further comprising the step of:
outputting a reset signal to the network chip by the controller to reset the network chip.
